(19) United States
(12) Patent Application Publication
(10) Pub. No.: US 2009/0307982 A1
(43) Pub. Date: Dec. 17, 2009

(54) DEVICE FOR SEALING THE GAP BETWEEN TWO HATCH COVERS AND STRIP PROVIDED THEREFOR

(75) Inventors: Matthias Romberg, Essen (DE); Rainer Meyer, Buhl (DE)

Correspondence Address: MATTHIAS SCHOLL, 14781 MEMORIAL DRIVE, SUITE 1319, HOUSTON, TX, 77079, US

(73) Assignee: BEMEKA TECHNOLOGIE-TRANSFER GMBH, Bühl (DE)

(21) Appl. No.: 12/520,876

(22) PCT Filed: Dec. 13, 2007
(86) PCT No.: PCT/DE07/02257

§ 371 Date: Jun. 23, 2009

(30) Foreign Application Priority Data
Dec. 27, 2006 (DE) 20 2006 019 693.5

(51) Int. Cl. E06B 7/16; B63B 19/26

(52) U.S. Cl. 49/478.1

(57) ABSTRACT

The invention relates to a device for sealing the gap (14) between two adjacent hatch covers (10) located at least at approximately the same height, having at least ferromagnetic hatch cover edges (13), wherein a flat flexible strip (1; 1′) is placed across the entire gap (14), wherein the width (Bs) and the length (Ls) of the strip are larger than the width (Bz) and the length (Lz) of the gap (14) and the longitudinal edges (3; 3′) protruding the width (Bz) of the gap (14) of which are placed on the adjacent hatch cover edges (13) in a plane manner under magnetic force.

The invention relates to a device according to the preamble of patent claim 1 and to a strip provided therefor.

In ships, in particular container and freight ships, a gap necessarily results between two adjacent, in particular horizontal, closed loading hatches. While the primary sealing of the loading hatch is protectively arranged below the hatch cover, the overlying slot-like gap between two adjacent hatch covers must also be sealed to prevent any foreign bodies, such as, for example, dust, water, snow and the like, from being able to enter and lodge in this gap so as then to drop into the hatch opening particularly upon opening of the hatch cover.

Two methods are applied in practice to seal such a gap, which amounts to approximately 10 mm when the ship is in the inoperative state: a first method uses a very complicated one-way system in which a fabric adhesive tape is adhesively bonded over said gap and onto the adjacent hatch cover edges, said tape being destroyed upon opening the hatches. Adhesive residues which result after each unloading of the freight must then be removed from, in particular scraped off, the hatch covers in a time-consuming manner, in order to ensure good adhesive bonding when such an adhesive tape is applied again. Scraping off adhesive residues frequently damages the coating applied to the hatch for corrosion protection purposes, thus resulting moreover also in new irregularities and rust on the adhesive surfaces. Such an adhesive seal in tape form is already known, for example, from JP 58-0 04 683 Y2.

A second method uses a clamping profile made of elastic rubber which is clamped into the gap and braced between the hatch cover edges. However, such a system employing a clamping profile presupposes that only gaps having a virtually identical and substantially uniform width are to be sealed and that the surfaces to be sealed have a planar and smooth design. Particularly in the case of older ships, this is by no means always ensured, however, on account of wear and plastic deformations. Such clamping profiles have been disclosed in various embodiments and cross-sectional shapes, for example as flat seals inserted in grooves in DE 18 55 353 U, as laterally disposed U-shaped seals in JP 2004-0 51 073 A, as laterally projecting and overlapping strip-shaped seals in JP 58-1 26 278 U, as wedge-shaped seals in JP 57-1 21 985 U, as rotatable multiple seals in JP 05-2 08 697 A and in the form of a gap-bridging, U-shaped covering in JP 06-0 16 178 Y2.

Although said gap is approximately 10 mm in size when the ship is in the inoperative state, for instance during a loading operation, it is known that, in particular owing to heavy seas, there can occur considerable distortions of the ship's hull and therefore relative movements between the hatch covers and the ship's hull, and hence also between adjacent hatch covers. For example, DE 196 46 793 A1 states that the degree of this relative movement is up to a maximum of 40 mm. Therefore, a seal must be able to securely seal a variable gap of 10 to 40 mm.

Document DE 39 08 991 A1 has already disclosed a so-called flat-form web of fluoroplastic for hatch cover seals on ships, said web having a smooth surface and comprising at least one reinforcing layer of fluorine-containing plastic film. Here, an edge portion of a specific elastic plastic strip is fastened by means of screws (not shown) to one of the adjacent hatch cover edges in such a way that the elastic edge portion which then projects freely bears in a sealing manner against the adjacent hatch cover edge. For this purpose, the strip is formed at a longitudinal edge with through holes for accommodating the screw shanks which are to be passed through. However, owing to its complicated fastening, such a strip is not suitable for the intended case of application herein at the upper sides of the hatches. Rather, it serves there as a further intermediate seal between the lower main seal and the upper seal to which the invention relates.

Based on the above-described facts which especially also apply in the case of ships of lightweight construction, the object of the invention is to provide a device whereby said gap can be sealed quickly, securely and in a repeatable manner. In addition, a strip for implementing this device is to be provided.

The invention therefore firstly proposes a device for sealing the gap between two adjacent hatch covers which are situated at least at approximately the same height and which at least have ferromagnetic hatch cover edges, which device is characterized in that a flat, flexible strip is placed over the entire gap, the width and length of said strip being larger than the width and length of the gap, and the outer longitudinal edges of said strip which project beyond the width of the gap being placed flat against the adjacent hatch cover edges under magnetic force.

Such a device makes it possible for the first time to effectively and permanently ensure secure and rapid sealing independently of fluctuations in the width of the gap. The flexible strip used as sealing means produces good adhesion and sealing in rough ship operation and, even with frequent use, simultaneously protects the sealing surfaces of the hatch cover since any damage or contamination due to adhesives or adhesive residues is eliminated. Such a strip according to the invention can be used again and again and, what is more, also by unskilled workers; even in spite of rough handling, it can be securely applied and removed again. Owing to its tape form, it is possible for the flexible strip, particularly during its removal from the gap, to be wound up into a roll which protects the sealing surfaces, to be transported and to be stored. For use, the roll is then unwound again over the gap and the strip is brought into its straight form in which it seals under magnetic action. The thus achieved rapid mounting and demounting of the sealing leads to a shortening of expensive ship lay times.

Slightly protruding ends of the strip can be used for gripping purposes so that the strip can be conveniently released again from the hatch cover edges without auxiliary means. However, the device for sealing can also be extended in that the two end portions of the strip that project beyond the length of the gap are bent over downwardly and placed flat against downwardly pointing edge portions of the two hatch covers under magnetic force. The gap is then also securely sealed laterally at its open ends.

As a rule, a hatch cover itself, and hence also the hatch cover edge, are made of a ferromagnetic material, such as, for example, steel. Should this not be so in an exceptional case, the invention can nevertheless be used, namely in that a ferromagnetic layer is applied to a non-ferromagnetic hatch cover edge and fixedly connected to the hatch cover edge. Such a layer may be applied in many different ways and may consist, for example, of a flat steel ribbon or the like fixedly connected to the hatch cover edge. Such a fixed, permanent connection can then be produced, for example, by adhesive bonding, screwing or riveting. The magnets of the strip then interact with that surface of the steel ribbon or the like which faces said magnets.

One embodiment of the device according to the invention can use in principle the form of a strip in tape form. Such a strip for sealing the gap between two adjacent hatch covers on a ship is U-shaped in cross section, and the free ends of the two U-legs are provided with magnetic means. During use of the strip, the U is inverted, i.e. the two U-legs point downwardly toward the respective hatch cover edge by way of their free ends which comprise the magnetic means.

In one embodiment, such a strip comprises a relatively wide and thin, flexible web strip which covers its entire width, and two relatively narrow and thick leg strips which are fixedly connected in a plane-parallel manner to the web strip at the edges thereof. Individual magnets having a high magnetic adhesion are arranged with a lateral spacing from one another in these leg strips.

The magnets can preferably have a flat cylindrical or round shape and be arranged in cutouts in the leg strips. Such cutouts can be expediently formed as shallow through holes or as blind holes whose shape and/or depth corresponds approximately to the shape and/or thickness of the magnets accommodated therein.

However, the magnets do not need to form an outer subsurface of the leg strips, but are enclosed all the way around. There are various possibilities of achieving this. In one configuration, provision is made for the blind holes arranged in the leg strip to be closed off by the web strip. In a variant to this, through holes or blind holes are closed off toward the free outer surface of a leg strip by a relatively thin, but strong, covering strip which extends over the entire length of the respective leg strip and plane-parallel thereto. In a similar manner to the residual material under a blind hole, such a covering strip should, on the one hand, be as thin as possible in order to reduce the effect of the magnetic forces as little as possible, but must, on the other hand, be thick or strong enough in order to transfer the magnetic pressing forces to the remainder of the strip to provide secure sealing. The thickness of a covering strip is thus also dependent on the material and may amount, for example, to approximately one millimeter. One embodiment of the leg strip with through holes can be produced by extruding and subsequent perforation.

The individual layers of the strip should be connected fixedly and permanently to one another as far as possible. For this purpose, provision can be made in particular for at least two adjacent strips, such as web strip, leg strip and, if appropriate, covering strip, to be adhesively bonded or welded to one another.

The material of the strip is tailored to the intended case of application. Permanent strength and good flexibility can be ensured in that in particular at least one of said strips is composed of a vulcanized rubber, and/or is reinforced with fabric, and/or is composed of a cellular material, and/or is composed of an extruded elastomer or thermoplastic or of a thermoplastic elastomer and/or of a weather-resistant and/or seawater-resistant material.

For a person skilled in the art, further particular advantages, features and details of the invention can also be taken from the description which follows of exemplary embodiments of the invention.

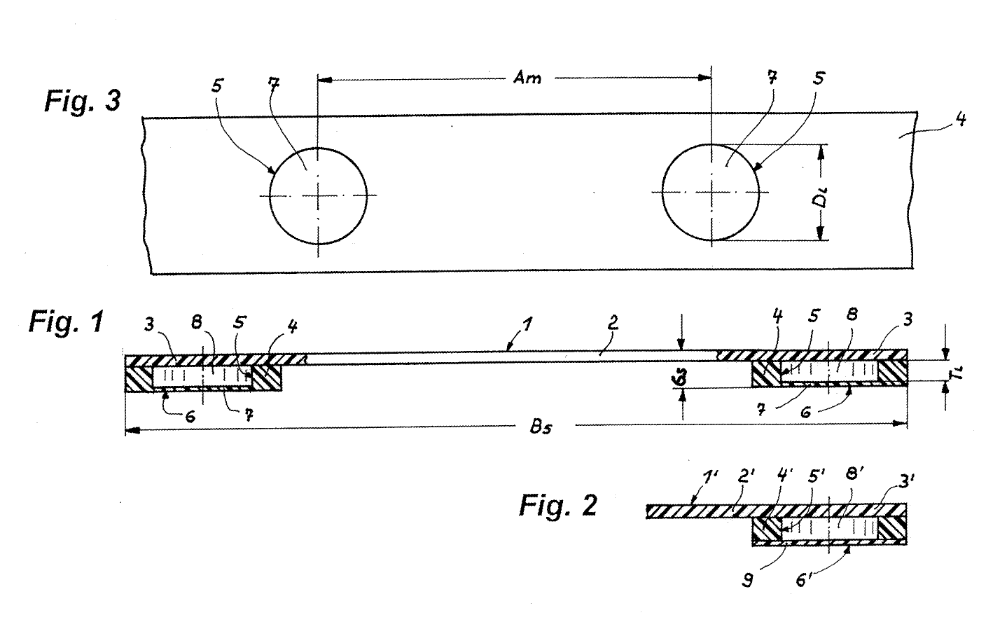

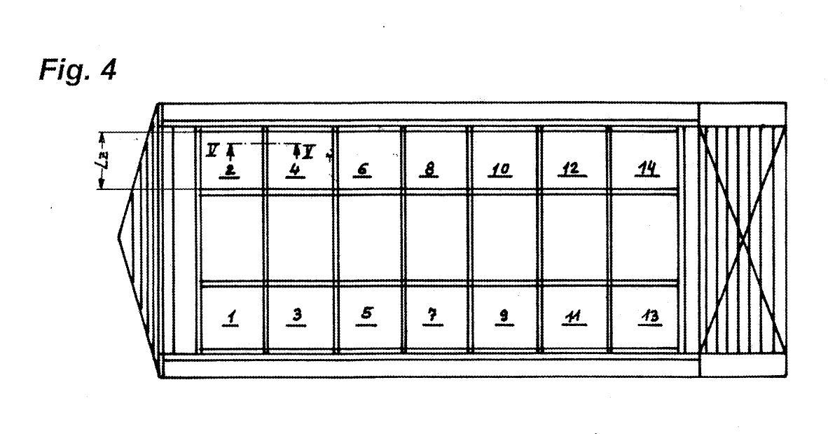

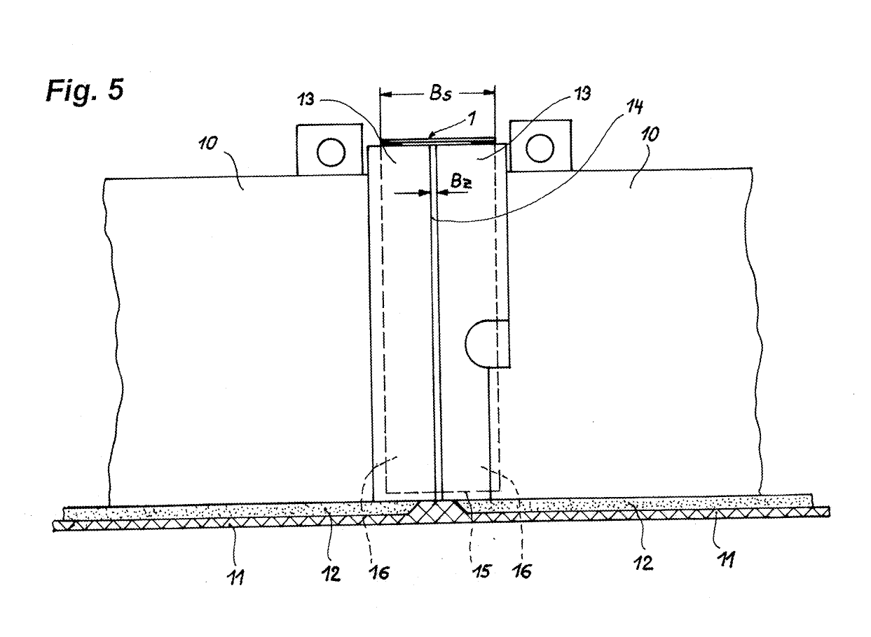

FIG. 1 shows a partial section through a first embodiment of a strip used in the device according to FIGS. 4 and 5, approximately on a scale of 1:1.

FIG. 2 shows a partial section through a second embodiment of a strip.

FIG. 3 shows a portion of a leg strip of the strip according to FIG. 1 in plan view.

FIG. 4 shows, in a schematic representation, a plan view of a ship's deck having two rows of sequentially numbered hatch covers arranged next to one another and intermediate center covers.

FIG. 5 shows the section V-V in FIG. 4, but on an enlarged scale, representing a gap between two adjacent hatch covers that is covered by a strip.

With a length Ls of about 11.80 m, the flexible strip 1 has a useful length tailored to the hatch length that is considerably larger than the length of a gap to be covered, and in cross section has in principle the shape of an inverted U having folding symmetry. According to FIG. 1, it is made up of a flexible, approximately 3-mm-thin web strip 2 which covers its entire width Bs of approximately 200 mm, each of the two edges 3 of which web strip are adhesively bonded or welded to an approximately 6-mm-thick leg strip 4 which runs parallel and which, having a width of approximately 40 mm, is relatively narrow when compared with the web strip. Cutouts in the form of blind holes 5 are made continuously in each leg strip 4 at a spacing Am, cf. FIG. 3, of approximately 100 mm and are closed off to the top by the edges 3 of the adhesively bonded web strip 2. The blind holes 5 have a circular diameter Dl of approximately 25 mm and a depth TI of approximately 6 mm, with the result that an approximately 1-mm-thick material web 7 of the leg strip 4 is present between a blind hole 5 and the free outer surface 6. The overall thickness Gs of the strip 1 is approximately 10 mm.

Cylindrical or round-shaped powerful magnets 8 are enclosed on all sides in the blind holes 5, with the magnetic action extending substantially perpendicularly with respect to the outer surface 6. The web strip 2 is reinforced by a central fabric inlay (not shown).

FIG. 2 shows a modification of the strip 1 in a partial view. Identical components are provided with reference signs which are the same but provided with an index. The modification relates to the illustrated leg strip 4′ of the strip 1′. Said leg strip here comprises cutouts in the form of through holes 5′ which enclose magnets 8′ and are closed off at the top by the web strip 2′ and at the bottom by an additional covering strip 9. The covering strip 9 takes the place as it were of the material web 7, shown in FIG. 3, below the blind hole 5. The covering strip 9 is approximately 1 mm thick and permanently adhesively bonded or welded to the leg strip 4′, which in turn is fixedly connected to the edge 3′ of the web strip 2′. Its outer side forms the outer surface 6′, which is intended to act as a sealing surface.

FIG. 3 shows a portion of a leg strip 4 of the strip 1 according to FIG. 1 in plan view. Here can be seen the circular shape of the shallow blind holes 5 with a diameter DI of 25 mm and a depth TI of 6 mm, which extend as far as the material web 7. The correspondingly shaped magnets 8 accommodated therein are depicted in FIG. 1.

FIGS. 4 and 5 show two adjacent hatch covers 10 on a ship, namely the hatch covers designated by 2 and 4 in FIG. 4, which tightly close the hatch openings 11 situated underneath. Seals 12 situated below are mainly used for this purpose. The in this case raised hatch cover edges 13 are made of steel and between them enclose a gap 14 having a width Bz of approximately 10 mm. In order to seal this gap 14 from above, a seal in the form of the strip 1 already described is placed thereon. In so doing, the strip 1 covers the width Bz of the gap 14 with its considerably larger width Bs of about 200 mm. It also covers the length Lz of the gap 14; this is because its end portions 15 which project beyond the gap are bent over downwardly as far as possible and bear in a sealing manner with magnetic adhesion against the vertical edge portions 16 of the two hatch covers 10. The thus bent-down end portions 15 of the strip 1 are represented by broken lines in FIG. 5.

### LIST OF REFERENCE SIGNS

1 Strip
1′ Strip
2 Web strip
2′ Web strip
3 Edge of 2
3′ Edge of 2′ 4 Leg strip
4′ Leg strip
5 Blind hole
5′ Through hole
6 Outer surface
6′ Outer surface
7 Material web
8 Magnet
8′ Magnet
9 Covering strip
10 Hatch cover
11 Hatch opening
12 Seal
13 Hatch cover edge
14 Gap
15 End portion
16 Edge portion
Bs Width of 1
Bz Width of 14
DI Diameter of 5
Gs Overall thickness of 1
Ls Length of 1
Lz Length of 14
Am Spacing
Ts Depth

1. A device for sealing the gap (14) between two adjacent hatch covers (10) which are situated at least at approximately the same height and which at least have ferromagnetic hatch cover edges (13), characterized in that a flat, flexible strip (1; 1′) is placed over the entire gap (14), the width (Bs) and length (Ls) of said strip being larger than the width (Bz) and length (Lz) of the gap (14), and the longitudinal edges (3; 3′) of said strip which project beyond the width (Bz) of the gap (14) being placed flat against the adjacent hatch cover edges (13) under magnetic force.

2. The device as claimed in claim 1, characterized in that the two end portions (15) of the strip (1) that project beyond the length (Lz) of the gap (14) are bent over downwardly and placed flat against downwardly pointing edge portions (16) of the two hatch covers (10) under magnetic force.

3. The device as claimed in claim 1 or 2, characterized in that a ferromagnetic layer is applied to a non-ferromagnetic hatch cover edge and fixedly connected to the hatch cover edge.

4. A strip (1; 1′) for sealing the gap (14) between two adjacent hatch covers (10) on a ship, in particular for a device as claimed in one of claims 1 to 3, characterized in that the strip (1; 1′) is U-shaped in cross section and the free ends of the two U-legs (4, 4′) are provided with magnetic means (8; 8′).

5. The strip (1; 1′) as claimed in claim 4, characterized in that the strip (1; 1′) comprises a relatively wide and thin web strip (2, 2′) which covers its entire width (Bs), and two relatively narrow and thick leg strips (4; 4′) which are fixedly connected in a plane-parallel manner to the web strip (2; 2′) at the edges (3; 3′) thereof.

6. The strip (1; 1′) as claimed in claim 5, characterized in that individual magnets (8; 8′) having a high magnetic adhesion are arranged with a lateral spacing (Am) from one another in the leg strips (1; 1′).

7. The strip (1; 1′) as claimed in claim 6, characterized in that the magnets (8; 8′) have a round shape.

8. The strip (1; 1′) as claimed in claim 6 or 7, characterized in that the magnets (8; 8′) are arranged in cutouts (5, 5′) in the leg strips (4; 4′).

9. The strip (1; 1′) as claimed in claim 8, characterized in that the cutouts are formed as shallow holes (5′) or blind holes (5) whose shape and/or depth (Ts) corresponds approximately to the shape and/or thickness of the magnets (8; 8′) accommodated therein.

10. The strip (1) as claimed in claim 9, characterized in that the blind holes (5) are closed off by the web strip (2).

11. The strip (1′) as claimed in claim 9, characterized in that the holes (5′) or blind holes are closed off toward the free outer surface (6′) of a leg strip (4′) by a relatively thin covering strip (9) which extends over the entire length of the respective leg strip (4′) and plane-parallel thereto.

12. The strip as claimed in one of claims 4 to 11, characterized in that at least two adjacent strips (web strip 1; 1′, leg strip 4; 4′, covering strip 9) are adhesively bonded or welded to one another.

13. The strip as claimed in one of claims 4 to 12, characterized in that at least one of the strips (1, 4; 1′, 4′, 9) is composed of a vulcanized rubber.

14. The strip as claimed in one of claims 4 to 13, characterized in that at least one of the strips (1, 4; 1′, 4′, 9) is reinforced with fabric.

15. The strip as claimed in one of claims 4 to 14, characterized in that at least one of the strips (1, 4; 1′, 4′, 9) is composed of a cellular material.

16. The strip as claimed in one of claims 4 to 15, characterized in that at least one of the strips (1, 4; 1′, 4′, 9) is composed of an extruded elastomer or thermoplastic or of a thermoplastic elastomer.

17. The strip as claimed in one of claims 4 to 16, characterized in that at least one of the strips (1, 4; 1′, 4′, 9) is composed of a weather-resistant and/or seawater-resistant material.
